(19) United States
(12) Patent Application Publication
(10) Pub. No.: US 2016/0141980 A1
(43) Pub. Date: May 19, 2016

(54) PIEZOELECTRIC ENERGY HARVESTING AND SIGNAL PROCESSING SYSTEM, AND METHOD OF USE

(71) Applicant: MicroGen Systems, Inc., West Henrietta, NY (US)

(72) Inventors: Robert A. Andosca, Fairport, NY (US); David Trauernicht, Rochester, NY (US); Kathleen M. Vaeth, Penfield, NY (US)

(21) Appl. No.: 14/541,376

(22) Filed: Nov. 14, 2014

(51) Int. Cl. H02N 2/18

(52) U.S. Cl. CPC H02N 2/183; H02N 2/188; H02N 2/181

(57) ABSTRACT

The present invention relates to a system comprising an energy harvester device and a signal processing device coupled to the energy harvester device. The energy harvester device includes an elongate resonator beam comprising a piezoelectric material extending between first and second ends. A base is connected to the elongate resonator beam at the first end with the second end being freely extending from the base as a cantilever. A mass attached to the second end of the elongate resonator beam. The signal processing device includes a processor and a memory coupled to the processor. The processor is configured to execute programmed instructions stored in the memory including obtaining a signal from the energy harvesting device. The obtained signal is tracked over a period of time. An environmental impact on the energy harvester device is determined based on the tracked signal.

### FIELD OF THE INVENTION

The present invention relates to a piezoelectric energy harvesting and signal processing system and methods of using the system to determine an environmental impact and to provide power to an electrically powered apparatus.

### BACKGROUND OF THE INVENTION

Vibrational energy harvester devices offer electrical power generation based on vibrations and/or movements. Vibrations in the form of either a vibration at a constant frequency or an impulse vibration containing a multitude of frequencies, can be scavenged (or harvested) to convert movement (e.g., vibrational energy) into electrical energy. The vibrations that result in the production of energy may result from impacts to a structural support of the vibrational energy harvester, or from temperature or pressure differentials, or fluid flow around the vibrational energy harvesting device.

One particular type of vibrational energy harvester utilizes resonant beams freely extending from a base as a cantilever that incorporate a piezoelectric material that generates electrical charge when strained during movement of the beams caused by ambient vibrations (driving forces), such as that described in U.S. patent application Ser. No. 14/173,131 to Vaeth et al. The movement of the beam may also be caused, for example, by environmental factors such as a fluid flow, an airflow, or a temperature or pressure differential about the beam.

Vibrational energy harvester devices may be utilized to power an electrically powered apparatus that also includes a sensor device to determine environmental impacts felt by the sensor device. Vibrational energy harvester devices may also be utilized to power such a sensor device independent of an electrically powered apparatus. The environmental impacts felt by the sensor device are often directly related to the same effect that causes movement or vibration of the energy harvester, such as either a vibration at a constant frequency, or an impulse vibration containing a multitude of frequencies, that provides for the power generation from the vibrational energy harvester device. The sensor devices, however, are separate from the energy harvester and require their own distinct mechanical structure and circuitry to sense the movement or vibration of the apparatus and determine the environmental impacts. The vibrational energy harvester devices are merely included to provide electrical power to the apparatus or to the sensor device. Inclusion of the sensor device increases cost and complicates the design of such an apparatus. Thus, there is a need for an improved vibrational energy harvester device that overcomes the increased cost and complexity created by the need for additional sensor devices that rely on the same vibrations or movements from which energy is harvested.

The present invention is directed to overcoming these and other deficiencies in the art.

### SUMMARY OF THE INVENTION

One aspect of the present invention relates to a system comprising an energy harvester device and a signal processing device coupled to the energy harvester device. The energy harvester device includes an elongate resonator beam comprising a piezoelectric material extending between first and second ends. A base is connected to the elongate resonator beam at the first end with the second end being freely extending from the base as a cantilever. A mass is attached to the second end of the elongate resonator beam. The signal processing device includes a processor and a memory coupled to the processor. The processor is configured to execute programmed instructions stored in the memory including obtaining a signal from the energy harvesting device. The obtained signal is tracked over a period of time. An environmental impact on the energy harvester device is determined based on the tracked signal.

A further aspect of the present invention relates to a method of determining an environmental impact. This method involves providing the system according to the present invention and subjecting the system to the environmental impact to generate electrical energy from the piezoelectric material. At least some of the electrical energy from the piezoelectric material is transferred to the signal processing device to determine the environmental impact.

The system of the present invention provides a piezoelectric energy harvesting and signal processing system. The system includes a piezoelectric energy harvesting device including a piezoelectric resonator beam that produces a charge (i.e., a voltage response) in response to straining of the piezoelectric material. The system advantageously allows for the determination of an environmental impact on the system utilizing the produced voltage response. The system further can simultaneously generate electrical power and determine the environmental impact on the system utilizing the voltage response from the piezoelectric energy harvesting device. This eliminates the need for a separate sensor device to measure and determine the environmental impact, which simplifies the design and saves on costs.

### BRIEF DESCRIPTION OF THE DRAWINGS

FIG. 1 is partial top view and partial block diagram of an embodiment of the system of the present invention.

FIGS. 2A and 2B are top views of embodiments of a piezoelectric energy harvesting device of the present invention with signal paths indicating the delivery of voltage produced by the energy harvesting device.

FIGS. 3A-3C illustrate an embodiment of a system of the present invention located in a tire. FIGS. 3A and 3B illustrate the attachment of the system directly to the tire (e.g., underneath the tire tread). FIG. 3C is a partial side view and partial block diagram of the system shown attached to the tire in FIGS. 3A and 3B.

FIG. 4 is a graph illustrating one embodiment of a voltage response of an energy harvester device component of the system of the present invention in response to a number of impulses received over a period of time.

FIG. 5 is a graph illustrating a sample curve showing the relationship between power ((voltage)/resistance) and acceleration for an energy harvesting device receiving impulses at a specific frequency, e.g., a resonance frequency of 120 Hz.

### DETAILED DESCRIPTION

The present invention relates to a piezoelectric energy harvesting and signal processing system and methods of using the system to determine an environmental impact and to provide power to an electrically powered apparatus. The system of the present invention advantageously harvests energy based on environmental impacts felt by the system, while simultaneously obtaining, storing, and/or communicating information regarding the environmental impacts felt by the system.

One aspect of the present invention relates to a system comprising an energy harvester device and a signal processing device coupled to the energy harvester device. The energy harvester device includes an elongate resonator beam comprising a piezoelectric material extending between first and second ends. A base is connected to the elongate resonator beam at the first end with the second end being freely extending from the base as a cantilever. A mass is attached to the second end of the elongate resonator beam. The signal processing device includes a processor and a memory coupled to the processor. The processor is configured to execute programmed instructions stored in the memory including obtaining a signal from the energy harvesting device. The obtained signal is tracked over a period of time. An environmental impact on the energy harvester device is determined based on the tracked signal.

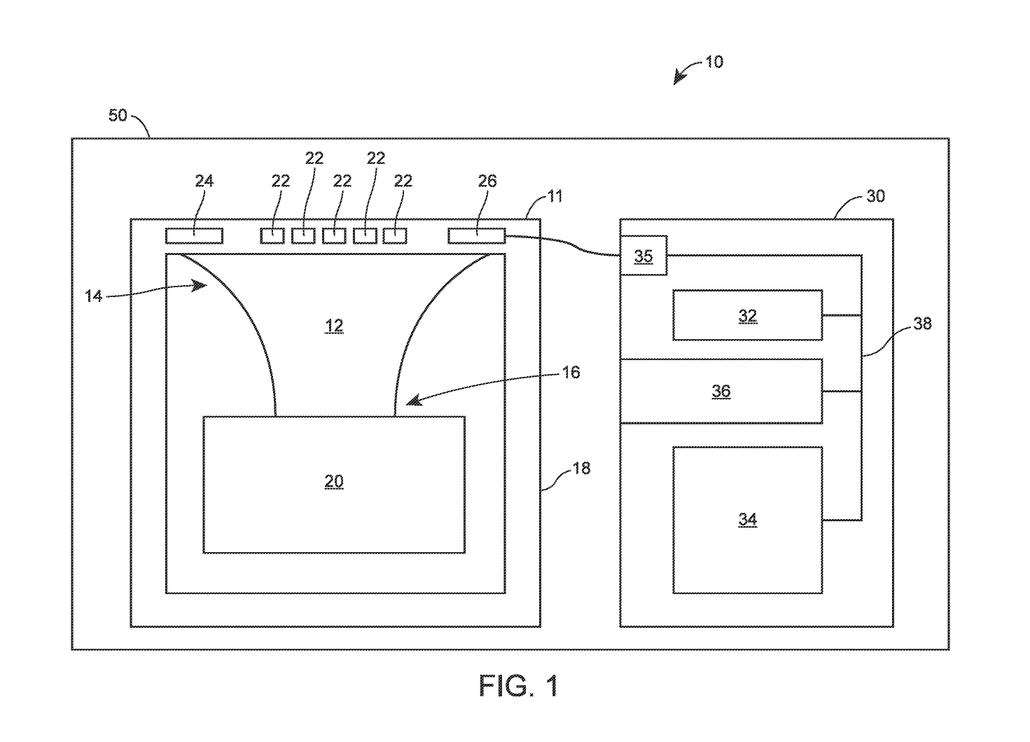

One embodiment of a piezoelectric energy harvesting and signal processing system of the present invention is illustrated in FIG. 1. FIG. 1 is a partial top view and partial block diagram of system 10 of the present invention that includes energy harvester device 11 coupled to a signal processing device 30. In one embodiment, energy harvester device 11 and signal processing device 30 are both located on and integral to printed circuit board (“PCB”) 50, although system 10 may have other configurations. By way of example, energy harvester device 11 and processing device 30 may be located on separate PCBs. In the system of the present invention, movement or vibration of energy harvester device 11, such as either a vibration at a constant frequency, an impulse vibration containing a multitude of frequencies, or a flow of a liquid, or pressure differential, around energy harvester device 11, generates an electrical signal that may be utilized for energy harvesting and for determining an environmental impact on system 10. In one embodiment, the energy harvesting and determining of an environmental impact occur simultaneously.

Referring again to FIG. 1, energy harvester device 11 includes elongate resonator beam 12 comprising a piezoelectric material, although energy harvester device 11 may include other numbers of resonator beams tuned to different resonant frequencies to provide a more consistent source of power as described, e.g., in U.S. patent application Ser. No. 14/260,930 to Trauernicht et al., which is hereby incorporated by reference in its entirety.

Resonator beam 12 extends between first end 14 and second end 16. First end 14 is connected to base 18 while second end 16 is freely extending from base 18 as a cantilever. Mass 20 is optional, but when present, is attached to second end 16 of resonator beam 12. Energy harvester device 11 may also include one or more electrodes 22 in electrical contact with the piezoelectric material of resonator beam 12. According to one embodiment, electrodes 22 may be constructed of molybdenum or platinum, although other materials suitable for forming electrode structures may also be used.

Energy harvester device 11 may further include electrical harvesting circuitry 24 in electrical connection with one or more of electrodes 22 to harvest electrical energy from the piezoelectric material of resonator beam 12, although electrical harvesting circuitry may be located separately on PCB 50. As described in further detail below, electrodes 22 and/or electrical harvesting circuitry 24 may be electrically coupled to power conversion circuitry to convert energy from the piezoelectric material of resonator beam 12 (generated during motion of energy harvester device 11) from AC to DC power. Energy harvester device 11 may also include electrical circuitry 26 in electrical connection with one or more of electrodes 22 to obtain a signal from the piezoelectric material of resonator beam 12 that may be utilized for further processing as described below, although electrical circuitry 26 may be separately located from energy harvester device 11 on PCB 50. Electrodes 22 and/or electrical circuitry 26 may be electrically coupled to one or more signal conditioning elements, such as an amplifier or a capacitor by way of example, for conditioning the obtained signal for further processing of the signal.

Resonator beam 12 of energy harvester device 11 includes a piezoelectric material. Suitable piezoelectric materials include, without limitation, aluminum nitride, scandium aluminum nitride, zinc oxide, polyvinylidene fluoride (PVDF), and lead zirconate titanate based compounds. Piezoelectric materials are materials that, when subjected to mechanical strain, become electrically polarized. The degree of polarization is proportional to the applied strain. Piezoelectric materials are widely known and available in many forms including single crystal (e.g., quartz), piezoceramic (e.g., lead zirconate titanate or PZT), thin film (e.g., sputtered zinc oxide), screen printable thick-films based upon piezoceramic powders (see, e.g., Baudry, “Screen-printing Piezoelectric Devices,” Proc. 6^{th} European Microelectronics Conference (London, UK) pp. 456-63 (1987) and White & Turner, “Thick-film Sensors: Past, Present and Future,” Meas. Sci. Technol. 8:1-20 (1997), which are hereby incorporated by reference in their entirety), and polymeric materials such as polyvinylidenefluoride (“PVDF”) (see, e.g., Lovinger, “Ferroelectric Polymers,” Science 220:1115-21 (1983), which is hereby incorporated by reference in its entirety).

Piezoelectric materials typically exhibit anisotropic characteristics. Thus, the properties of the material differ depending upon the direction of forces and orientation of the polarization and electrodes. The level of piezoelectric activity of a material is defined by a series of constants used in conjunction with the axes of notation. The piezoelectric strain constant, d, can be defined as

$$d = \frac{strain developed}{applied field} m / V$$

(Beeby et al., “Energy Harvesting Vibration Sources for Microsystems Applications,” Meas. Sci. Technol. 17:R175-R195 (2006), which is hereby incorporated by reference in its entirety).

In energy harvester device 11, resonator beam 12 has second end 16, which is freely extending from base 18 as a cantilever. A cantilever structure comprising piezoelectric material is designed to operate in a bending mode thereby straining the piezoelectric material and generating a charge from the d effect (Beeby et al., “Energy Harvesting Vibration Sources for Microsystems Applications,” Meas. Sci. Technol. 17:R175-R195 (2006), which is hereby incorporated by reference in its entirety). A cantilever provides low resonant frequencies, reduced further by the presence of mass 20 attached at second end 16 of resonator beam 12.

Resonant frequencies of energy harvester 11 of the present invention in operation may include frequencies of about 50 Hz to about 4,000 Hz, about 100 Hz to about 3,000 Hz, about 100 Hz to about 2,000 Hz, or about 100 Hz to about 1,000 Hz.

According to one embodiment, resonator beam 12 comprises a laminate formed of a plurality of layers. Some of the layers may include piezoelectric materials as discussed supra. However, other non-piezoelectric materials may also be used as layers along with one or more layers of piezoelectric material. Non-limiting examples of other layers include those described in U.S. patent application Ser. No. 14/173,131 to Vaeth et al., which is hereby incorporated by reference in its entirety. In one particular embodiment, the plurality of layers comprises at least two different materials.

Resonator beam 12 may have sidewalls that take on a variety of shapes and configurations to help tuning of resonator beam 12 and to provide structural support. According to one embodiment, resonator beam 12 has sidewalls which are continuously curved within the plane of resonator beam 12, as described in U.S. patent application Ser. No. 14/145,534 to Andosca & Vaeth, which is hereby incorporated by reference in its entirety.

Energy harvester 11 includes mass 20 at second end 16 of resonator beam 12. Mass 20 is provided to lower the frequency of resonator beam 12 and also to increase the power output of resonator beam 12 (i.e., generated by the piezoelectric material). Mass 20 may be constructed of a single material or multiple materials (e.g., layers of materials). According to one embodiment, mass 20 is formed of silicon wafer material. Other suitable materials include, without limitation, copper, gold, and nickel deposited by electroplating or thermal evaporation.

In one embodiment, a single mass 20 is provided per resonator beam 12. However, more than one mass may also be attached to resonator beam 12. In other embodiments, mass 20 is provided, for example, at differing locations along resonator beam 12.

Energy harvester 11 may be formed in an integrated, self-packaged unit. In particular, as illustrated in FIG. 1, package 18, which also forms the base to which first end 14 of resonator beam 12 is attached, is shown to surround the cantilever structure (i.e., resonator beam 12 and mass 20) so that it encloses (at least partially) the cantilever structure. In the present invention, the package can completely enclose the energy harvester device, or can be formed so as to vent the energy harvester device to the atmosphere. When it completely encloses the energy harvester device, the pressure within the enclosed package may be higher, equal to, or lower than atmospheric pressure. In one embodiment, the atmosphere in the enclosed package is less than atmospheric, for example, below 1 Torr.

In one embodiment, package 18 may further comprise a compliant stopper connected to the package (e.g., on an inside wall of the package), where the stopper is configured to stabilize motion of the cantilever to prevent breakage. Suitable compliant stoppers according to this embodiment of the energy harvester device are illustrated and described in U.S. patent application Ser. No. 14/173,131 to Vaeth et al., which is hereby incorporated by reference in its entirety. The compliant stopper of the energy harvester device may be constructed of a variety of materials. The stopper may be made compliant through material choice, design, or both material choice and design. According to one embodiment, the stopper is made from a material integral to the package. Suitable materials according to this embodiment may include, without limitation, glass, metal, silicon, oxides or nitrides from plasma-enhanced chemical vapor deposition (PECVD), or combinations thereof. According to another embodiment, the stopper is not integral to the package. Suitable materials for the stopper according to this embodiment may include, without limitation, glasses, metals, rubbers and other polymers, ceramics, foams, and combinations thereof. Other suitable materials for the compliant stopper include polymers with low water permeation, such as, but not limited to, cycloolefin polymers and liquid crystal polymers. Liquid crystal polymers can be injection molded.

In an alternative embodiment, resonator beam 12 may be configured to have a stopper feature which is configured to stabilize motion of the cantilever. Suitable stopper features according to this embodiment are illustrated in U.S. patent application Ser. No. 14/145,560 to Andosca et al., which is hereby incorporated by reference in its entirety. According to this embodiment, a stopper is formed on the mass and/or the second end of the resonator beam, and is configured to prevent contact between the second end of the resonator beam and the package.

Resonator beam 12 can be tuned by varying any one or more of a number of parameters, such as the cross-sectional shape of resonator beam 12, cross-sectional dimensions of resonator beam 12, the length of resonator beam 12, the mass of mass 20, the location of mass 20 on resonator beam 12, and the materials used to make resonator beam 12.

Energy harvester 11 may be made in accordance with the methods set forth, e.g., in U.S. patent application Ser. No. 14/145,534 to Andosca & Vaeth; U.S. patent application Ser. No. 14/173,131 to Vaeth et al.; and U.S. patent application Ser. No. 14/201,293 to Andosca et al., which are hereby incorporated by reference in their entirety. For example, according to one embodiment, a method of producing an energy harvester device involves providing a silicon wafer having a first and second surface. A first silicon dioxide (SiO₂) layer is deposited on the first surface of the silicon wafer. A cantilever material is deposited on the first silicon dioxide layer. A second silicon dioxide layer is deposited on the cantilever material. A piezoelectric stack layer is deposited on the second silicon dioxide layer. The piezoelectric stack layer, the second silicon dioxide layer, the cantilever material, and the first silicon dioxide layer are patterned. The second surface of the silicon wafer is etched to produce the energy harvester device.

In another embodiment, a method of producing an energy harvester device involves providing a silicon wafer having a first and second surface. A first silicon dioxide layer is deposited on the first surface of the silicon wafer. A first piezoelectric stack layer is deposited on the first silicon dioxide layer and patterned. A second silicon dioxide layer is deposited over the patterned first piezoelectric stack layer. A structural layer is deposited over the deposited second silicon dioxide layer and patterned. A second piezoelectric stack layer is deposited over the patterned structural layer and the second piezoelectric stack layer is patterned to produce the device.

Referring again to FIG. 1, signal processing device 30 is coupled to energy harvester device 11 through electrical circuitry 26 located on energy harvester device 11. In another embodiment, electrical circuitry 26 is located on and is integral to PCB 50 that holds energy harvester device 11 and signal processing device 30, although electrical circuitry 26 may be located on a separate chip or board. Various signal conditioning elements known in the art, such as an amplifier or a capacitor, may be located between energy harvester device 11 and signal processing device 30 to provide an adjusted signal for further signal processing.

Signal processing device 30 includes processor 32, memory 34, input 35, communication interface 36, all of which are coupled together by bus 38 or other link, although other numbers and types of components, parts, devices, systems, and elements in other configurations and locations can be used. Processor 32 in signal processing device 30 executes a program of stored instructions for one or more aspects of the present invention as described and illustrated by way of the embodiments described herein, although processor 32 could execute other numbers and types of programmed instructions. Processor 32 in signal processing device 30 may include one or more central processing units or general purpose processors with one or more processing cores, for example.

Memory 34 in signal processing device 30 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to processor 32, can be used for memory 34 in signal processing device 30.

Input 35 in signal processing device 30 provides an interface between signal processing device 30 and energy harvester device 11 through electrical circuitry 26. Various signal conditioning elements may be utilized to transfer the voltage produced by energy harvester device 11 to signal processing device 30.

Communication interface 36 in signal processing device 30 is used to operatively couple and communicate between signal processing device 30 and one or more other computing devices via a communication network, although other types and numbers of communication networks with other types and numbers of connections and configurations can be used. The communication network can include one or more local area networks (LANs) and/or wide area networks (WANs). By way of example only, the communication networks can use TCP/IP over Ethernet and industry-standard protocols, including hypertext transfer protocol (HTTP) and/or secure HTTP (HTTPS), for example, although other types and numbers of communication networks also can be used.

In operation, one or more electrodes 22 harvest charge (i.e. a generated voltage response) from the piezoelectric material of resonator beam 12 as resonator beam 12 is caused to move or vibrate, such as a vibration at a constant frequency, an impulse vibration containing a multitude of frequencies, or a temperature or pressure differential, or a flow of fluid around energy harvester device 11. In one embodiment, the energy is harvested based on impacts received by the energy harvester device that cause resonator beam 12 to vibrate and ring down. In another embodiment, resonator beam 12 is caused to vibrate in resonance mode by a consistent source of vibrations. Accordingly, electrodes 22 are in electrical connection with the piezoelectric material of resonator beam 12.

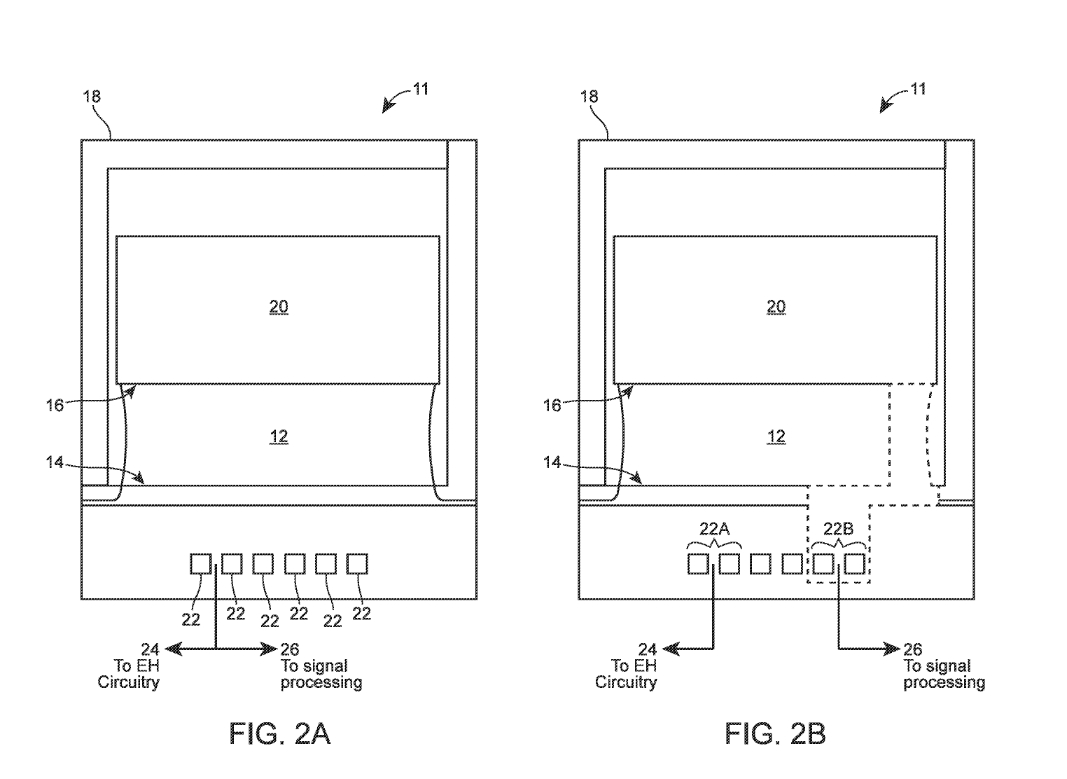

The electrical energy (produced voltage) collected from the piezoelectric material of resonator beam 12 is then communicated to electrical harvesting circuitry 24 and electrical circuitry 26. In one embodiment, as illustrated in FIG. 2A, each of the electrodes 22 are electrically connected to the piezoelectric material, such that each of the electrodes 22 receives the signal from the piezoelectric material and provides the signal to electrical harvesting circuitry 24 and electrical circuitry 26. In another embodiment illustrated in FIG. 2B, electrodes 22A and electrodes 22B are electrically isolated and provide separate signals to electrical harvesting circuitry 24 and electrical circuitry 26, respectively. As shown in FIG. 2B, the dashed portion of energy harvester device 11 surrounding electrodes 22B is electrically isolated from the rest of energy harvester device 11. In this example, the electrically isolated portion of energy harvester device 11 dedicated to signal processing is smaller than the remainder of energy harvester device 11.

Electrodes 22 and/or electrical harvesting circuitry 24 may be electrically coupled to power conversion circuitry to convert energy from the piezoelectric material of resonator beam 12 (generated during motion of energy harvester device 11) from AC to DC power. The DC power output may be utilized to power signal processing device 30. In one embodiment, the power conversion circuitry is coupled to an electrically powered apparatus. System 10 of the present invention may also power an electrically powered apparatus by charging a battery associated with the electrically powered apparatus. For example, system 10 may provide a trickle charge to a coin cell rechargeable battery which powers the electrically powered apparatus. System 10 may also trickle charge a thin film battery such as those made by Cymbet Corporation. System 10 may also supply energy for storage in a supercap or bank of capacitors. System 10 may be utilized, by way of example, to power a wireless transmitter such as a narrow or ultra wide band RF transmitter.

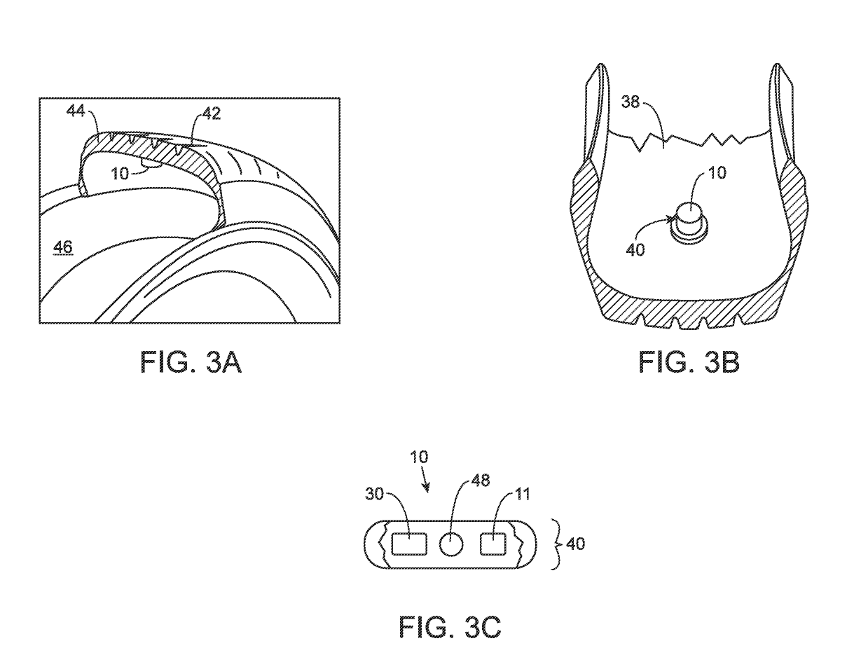

Turning now to FIG. 3, according to one embodiment, system 10 of the present invention is located within housing 40, which is installed on tire 42. System 10 is coupled to tire 42 on the underside of tire 42 (i.e., under tire tread 44 and between tread 44 and wheel rim 46, although system 10 may be located in other locations on tire 42. In this embodiment, energy harvester device 11 and signal processing device 30 are located within housing 40 and in electrical communication with housing 40. In one embodiment, system 10 further includes optional energy storage 48 in electrical communication with energy harvester device 11 and located within housing 40. According to this embodiment, energy harvester device 11 provides a standalone source of energy to power system. Energy harvester device 11 of the present invention may also power an electrically powered apparatus by charging energy storage 48 associated with the electrically powered apparatus. Energy storage 48 may be a capacitor bank or a super-capacitor, although in other applications energy storage 48 may be a rechargeable battery. For example, the energy harvester device may provide a trickle charge to energy storage 48 which powers the electrically powered apparatus.

In this embodiment, system 10 is mounted directly to tire 42 such that motion of resonator beam 12 of energy harvester device 11 is excited as a result of impulses generated as tire 42 enters the footprint region of rotation (i.e., as tire 42 meets the road at the point where system 10 is attached to tire 42). Signal processing device 30 may determine a number of impulses to serve as a tire rotation counter. Alternatively, signal processing device 30 may determine changes in voltage output from energy harvester device 11 to determine changes in tire pressure, road conditions, vehicle weight, or tread depth, by way of example.

In another embodiment, system 10 is mounted to a machine and serves as a vibration sensor. In this embodiment, the machine provides a constant, fixed frequency source of vibration to system 10 resulting in an output voltage signal from energy harvester device 11 to signal processing device 30. Signal processing device 30 may determine changes in the output signal to determine the operation status of the machine. By way of example, if the voltage (acceleration level at the operating frequency) falls below a certain level, signal processing device 30 may provide an alert that the machine is not operating optimally and that remedial action must be taken.

In an alternative embodiment, the electrically powered apparatus is, by way of example, a wearable device, such as a wrist watch-type device or necklace that electronically communicates with a tablet, PC, and/or smartphone.

Other electrically powered apparatus that may be powered and monitored by the system of the present invention include, without limitation, a laptop computer; a tablet computer; a cell phone; an e-reader; an MP3 player; a telephony headset; headphones; a router; a gaming device; a gaming controller; a mobile internet adapter; a camera; wireless sensors; wearable sensors that communicate with tablets, PCs, and/or smartphones; wireless sensor motes (for networks monitoring industrial, rail, buildings, agriculture, etc.); tire pressure sensor monitors; a tire pressure management system that includes a tire pressure monitor as well as sensors to monitor other factors such as number of revolutions or acceleration of the tire; electronic displays (e.g., on power tools); agriculture devices for monitoring livestock; medical devices; human body monitoring devices; and toys.

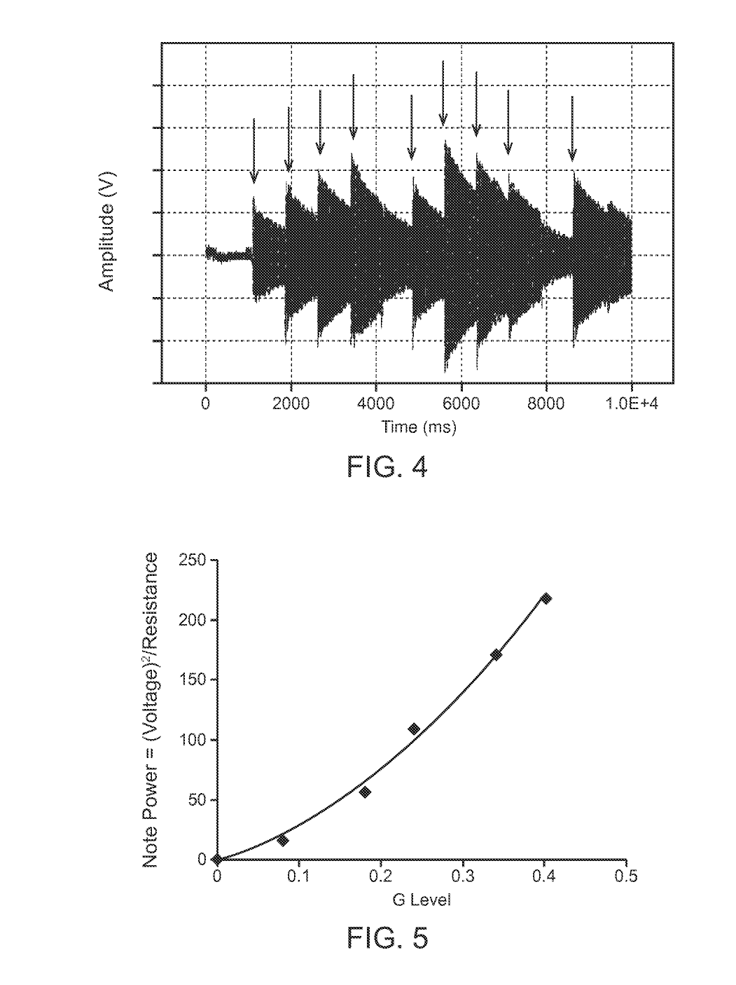

Electrodes 22 and/or electrical circuitry 24 may be electrically coupled to signal processing device 30 through interface 35, such that signal processing device 30 may obtain a signal from the energy harvester device 11. In one embodiment, the signal is a voltage response generated by the piezoelectric material of resonator beam 12 of energy harvester device 11 in response to movement or vibration of system 10, although the signal may be a change in voltage level of the response generated by the piezoelectric material of resonator beam 12 of energy harvester device 11 due to changes in the environment. In one embodiment, the movement or vibration of resonator beam 12 is an impulse (i.e., an abrupt change in acceleration of resonator beam 12). Energy harvester device 11 may be subjected to a number of impulses over a period of time. FIG. 4 shows a graph of the voltage response created by energy harvester device 11 in response to impulses to which system 10 is subjected. In one embodiment, the motion or vibration may be a continuous vibration that occurs at a specific frequency. The movement or vibration may cause resonator beam 12 to vibrate in a resonant mode. In another embodiment, the signal is a change in the voltage response level resulting from a change in the amplitude of movement of the system 10, which is caused by a change in the acceleration level. The signal (i.e., the generated voltage) may be conditioned by one or more elements, such as an amplifier or a capacitor, prior to being obtained through interface 35 of signal processing device 30.

Signal processing device 30 tracks the obtained signal over a period of time. By way of example, signal processing device 30 may obtain data regarding the voltage produced over a period of time. Signal processing device 30 may store the data in memory 34, although the voltage data may be stored in other locations on other devices.

Signal processing device 30 then determines an environmental impact on energy harvester device 11. In one embodiment, the environmental impact may be a number of impulses felt by energy harvester device 11 over a period of time. The number of impulses may be counted, by way of example, for use as a tire rotation counter, machines or other tooling for which the number of impacts is relevant, or a pedometer. The environmental impact also may be a rate at which the impulses are received, or the magnitude of the impulses received. In one embodiment, when the impulses are received at a specific frequency, the obtained signal can be utilized to determine the input frequency and an acceleration level. FIG. 5 illustrates a sample graph of power (voltage²/resistance) versus acceleration for an energy harvesting device operating at a resonance frequency. The magnitude of the input voltage can be utilized to determine the acceleration level. Further, when the input is at a specific frequency, changes in the characteristic curve shown in FIG. 5 can be utilized to determine other environmental impacts on energy harvester device 11, such as, by way of example, pressure, flow rate, or acceleration.

In another embodiment, the environmental impact is based on a change in the voltage response generated by the piezoelectric material in response to increased or decreased motion of energy harvester device 11. By way of example, signal processing device 30 may determine that a machine that produces a constant source of vibration is not functioning properly based on a decrease in the output voltage from energy harvester device 11. The change in voltage can also be utilized for tread depth sensors, vehicle weight sensors, or other uses where the change in the voltage profile may be used to determine an environmental impact. In these examples, the output voltage profile would depend on how much the tire presses into the road; as the tire presses into the road, the voltage response from energy harvester device 11 changes. The voltage profile can therefore be correlated to the tire pressure or the weight of the vehicle. In another example, signal processing device 30 may determine a road condition, i.e., whether a vehicle is hydroplaning based on the voltage response from a sensor in a tire of the vehicle.

A further aspect of the present invention relates to a method of determining an environmental impact. This method involves providing the system according to the present invention and subjecting the system to movement or vibrations to generate electrical energy from the piezoelectric material. At least some of the electrical energy from the piezoelectric material is transferred to the signal processing device to determine the environmental impact.

Referring to FIG. 1, an exemplary method for determining an environmental impact using system 10 is described. System 10 is subjected to movement or vibrations. The movement or vibrations cause the piezoelectric material of resonator beam 12 of energy harvester device 11 to strain, resulting in the generation of electrical energy. At least some of the generated electrical energy (i.e., voltage) is transferred from the piezoelectric material to signal processing device 30 through circuitry 26, which is connected to one or more of electrodes 22 on energy harvester device 11. The electrical energy transferred is utilized by signal processing device 30 to determine the environmental impact on energy harvester device 11 as described above. In one embodiment, upon determining an environmental impact, signal processing device 30 takes further action, such as providing a signal to another device through communication interface 35. In one embodiment, the communication is done via a wireless transmitter.

In one embodiment of the method of the present invention, the system includes an electrically powered apparatus electrically coupled to the energy harvester device, as discussed supra, and the method further involves powering the electrically powered apparatus. This particular embodiment of the method of the present invention includes transferring at least some of the electrical energy generated by the piezoelectric material to the electrically powered apparatus to provide power to the apparatus.

In another embodiment, at least some of the electrical energy generated in response to strain of the piezoelectrical material of resonator beam 12 is transferred through energy harvesting circuitry to the coupled electrically powered apparatus, such as system 10 installed on tire 42 as shown in FIG. 3. The transferred electrical energy provides power to the electrically powered apparatus.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A system comprising:
an energy harvester device comprising:
an elongate resonator beam comprising a piezoelectric material extending between first and second ends;
a base connected to said elongate resonator beam at the first end with the second end being freely extending from said base as a cantilever;
a mass attached to the second end of said elongate resonator beam; and
a signal processing device coupled to the energy harvester device, the signal processing device comprising:
a processor; and
a memory coupled to the processor, wherein the processor is configured to execute programmed instructions stored in the memory comprising:
obtaining a signal from the energy harvesting device;
tracking the obtained signal over a period of time; and
determining, based on the tracked signal, an environmental impact on the energy harvester device.

2. The system of claim 1, wherein the energy harvester device further comprises:
one or more electrodes in electrical contact with the piezoelectric material.

3. The system of claim 2, wherein the energy harvester device further comprises:
electrical harvesting circuitry in electrical connection with the one or more electrodes to harvest electrical energy from the piezoelectric material.

4. The system of claim 2, wherein the signal processing device further comprises:
electrical circuitry in electrical connection with the one or more electrodes by which the signal is obtained from the energy harvesting device.

5. The system of claim 1, wherein the piezoelectric material is selected from the group consisting of aluminum nitride, scandium aluminum nitride, zinc oxide, polyvinylidene fluoride (PVDF), and lead zirconate titinate compounds.

6. The system of claim 1, wherein the signal obtained from the energy harvesting device is a voltage response generated by the piezoelectric material in response to the environmental impact.

7. The system of claim 6, wherein the environmental impact is movement or vibration of the energy harvester device.

8. The system of claim 7, wherein the environmental impact comprises a number of impulses on the energy harvester device over the period of time.

9. The system of claim 7, wherein the environmental impact comprises an acceleration level of an impact on the energy harvesting device.

10. The system of claim 7, wherein the environmental impact is based on a change in the voltage response generated by the piezoelectric material in response to increased or decreased motion of the energy harvester device.

11. The system of claim 1 further comprising:
an electrically powered apparatus electrically coupled to the energy harvester device.

12. The system of claim 11, wherein said electrically powered apparatus is selected from the group consisting of a laptop computer, a tablet computer, a cell phone, a smart phone, an e-reader, an MP3 player, a telephony headset, headphones, a router, a gaming device, a gaming controller, a mobile internet adapter, a camera, wireless sensors, wireless sensor motes, tire pressure sensor monitors, a tire management system, powering simple displays on power tools, devices for raising livestock, medical devices, human body monitoring devices, and toys.

13. A method of determining an environmental impact, said method comprising:
providing the system according to claim 2;
subjecting the system to the environmental impact to generate electrical energy from the piezoelectric material; and
transferring at least some of said electrical energy from the piezoelectric material to the signal processing device to determine the environmental impact.

14. The method of claim 13, wherein the energy harvester device further comprises:
electrical harvesting circuitry in electrical connection with the one or more electrodes to harvest electrical energy from the piezoelectric material.

15. The method of claim 13, wherein the signal processing device further comprises:
electrical circuitry in electrical connection with the one or more electrodes to obtain the signal from the energy harvesting device.

16. The method of claim 13, wherein the piezoelectric material is selected from the group consisting of aluminum nitride, scandium aluminum nitride, zinc oxide, polyvinylidene fluoride (PVDF), and lead zirconate titinate compounds.

17. The method of claim 13 wherein the signal obtained from the energy harvesting device is a voltage response generated by the piezoelectric material in response to the environmental impact.

18. The method of claim 17, wherein the environmental impact is movement or vibration of the energy harvester device.

19. The method of claim 17, wherein the environmental impact comprises a number of impulses on the energy harvester device over the period of time.

20. The method of claim 17, wherein the environmental impact comprises an acceleration level of an impact on the energy harvesting device.

21. The method of claim 17, wherein the environmental impact is based on a change in the voltage response generated by the piezoelectric material in response to increased or decreased motion of the energy harvester device.

22. The method of claim 13, further comprising:
transferring at least some of said electrical energy from the piezoelectric material to an electrically powered apparatus to provide power to the apparatus.

23. The method of claim 22, wherein the transferred electrical energy from the piezoelectric material to said apparatus to provide power to the apparatus and the transferred electrical energy from the piezoelectric material to the signal processing device to determine the environmental impact are transferred simultaneously.

24. The method of claim 22, wherein the transferred electrical energy from the piezoelectric material to said apparatus to provide power to the apparatus and the transferred electrical energy from the piezoelectric material to the signal processing device to determine the environmental impact are transferred from a same one of the one or more electrodes.

25. The method of claim 22, wherein said apparatus is selected from the group consisting of a laptop computer, a tablet computer, a cell phone, a smart phone, an e-reader, an MP3 player, a telephony headset, headphones, a router, a gaming device, a gaming controller, a mobile internet adapter, a camera, wireless sensors, wireless sensor motes, tire pressure sensor monitors, a tire management system, powering simple displays on power tools, devices for raising livestock, medical devices, human body monitoring devices, and toys.

26. The method of claim 13 further comprising:
transferring at least some of said electrical energy from the piezoelectric material to the signal processing device to provide power to the signal processing device.
